(19) United States
(12) Patent Application Publication
(10) Pub. No.: US 2003/0211031 A1
(43) Pub. Date: Nov. 13, 2003

(54) Ferrous chloride conversion

(76) Inventor: Valery L. Temyanko, Tucson, AZ (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/181,568

(22) PCT Filed: Jan. 18, 2001
(86) PCT No.: PCT/US01/01611

(51) Int. Cl. C01G 49/10; C01B 7/01

(52) U.S. Cl. 423/493; 422/188; 422/189

(57) ABSTRACT

To produce ferric chloride, pickle liquor containing ferrous chloride and fortified with sufficient HCl is converted to ferric chloride in the presence of oxygen in a tower at a temperature above 132° F. The ferric chloride solution from the tower is subjected to evaporation so as to increase the concentration of the ferric chloride. The resultant concentrate is recycled into the tower until a concentration of about 40% by weight ferric chloride is obtained. A gas phase from either or both of the tower and the evaporator is scrubbed in order to remove HCl which can be used to fortify the pickle liquor.

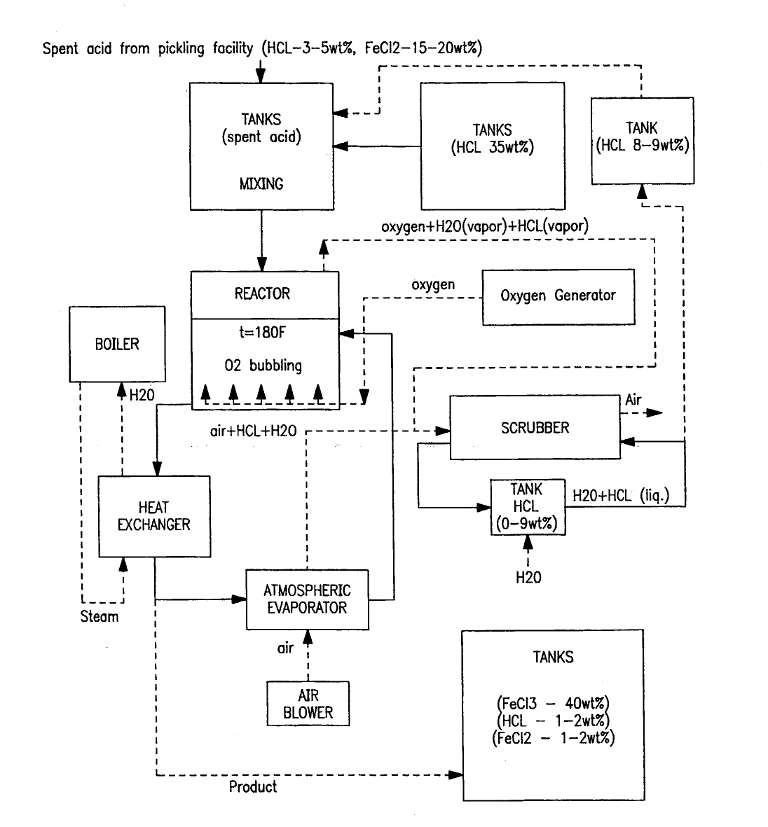

Benefit is claimed under 35 U.S.C. 119(e) of Provisional Applications: 60/176,490 filed Jan. 18, 2000, 60/190,026 filed Mar. 17, 2000 and 60/221,197 filed July 27, 2000, all bearing the title Ferrous Chloride Conversion with the inventor being Valery L. Temyanko.

This invention relates to a process for converting ferrous chloride to ferric chloride.

It is well known that in the production of steel, especially strip steel, in order to improve the quality of the surface of the steel, it is subjected to treatment with a solution of hydrochloric acid. Riegel's Handbook of Industrial Chemistry, Kent, 7th Edition, 1974, Van Nostrandl Reinhold Co. N.Y. p. 841. This step is called “pickling”, and the resultant liquor from this step containing ferrous chloride “FeCl₂” is called “pickle liquor”. In general, the waste pickle liquor from such a treatment comprises an aqueous solution of about 3-5% HCl and 15-20 weight percent of ferrous chloride.

Several methods have been proposed for economically treating the pickle liquor in order to dispose of same and/or for converting the liquor to an easily disposable and/or useful product, e.g. ferric chloride (FeCl₃). For example, one process involves treating the pickle liquor with chlorine gas in order to convert the ferrous chloride to ferric chloride. However, this latter process is less than desirable because of the cost, toxicity and safety problems associated with a chlorination step.

An objective of the present invention is not only to provide an improved process for treating pickle liquor, but also to provide a process for the conversion of ferrous chloride to ferric chloride irrespective of the source of the ferrous chloride.

Another object is to provide apparatus to conduct the process.

Upon further study of this application, other objects and advantages of the invention will become apparent.

To attain these objects, an essential aspect of the present invention comprises a step of reacting an aqueous solution of ferrous chloride at temperatures above 50° C. (132° F.) in contact with an oxygen-containing gas which can be air, but preferably oxygen-enriched air up to 100% oxygen. It is preferred that this reaction be conducted in a tower with the oxygen-containing gas being introduced at the bottom of the reactor and the ferrous chloride solution being introduced to the top of the reactor. The preferred temperature range is about 150 to 180° F. and the preferred temperature is about 180° F. Whereas higher temperatures are theoretically feasible, an economic analysis would be required to determine if the additional cost of high temperature and acid-resistant materials of construction e.g. glass-lined stainless steel, for the reactor would justify any advantages obtained by the use of higher temperatures. Conversely, at 180° F., it is preferable to use fiber glass reinforced polymers e.g. a polyester-fiber glass system such as Derakane, but other materials are also feasible. Conversely, if the reaction is conducted at a temperature lower than 50° C., then the rate of reaction becomes so slow that it would be necessary to increase the size and/or number of reactors to an extent that the investment and operating costs of the process would be economically unattractive.

According to a further embodiment of the invention, the pickle liquor entering the reactor is enriched with HCl so that the resultant pickle liquor contains a sufficient concentration of Cl⁻ ions to convert substantially all the FeCl₂ to FeCl₃, but at the same time, the concentration of HCl should not exceed about 2% by weight in the final product.

According to a still further embodiment of the invention, the oxygen-containing gas passed into the reactor is an enriched oxygen gas obtained from a conventional oxygen generator, e.g. by a conventional membrane or cryogenic system.

The resultant ferric chloride solution is then withdrawn from the reactor. According to a preferred embodiment of the invention, the ferric chloride solution is evaporated sufficiently so as to obtain a product comprising an aqueous solution comprising at least about 40 weight percent of ferric chloride, with contaminants of HCl and FeCl₂, e.g. about 12 weight percent of HCl and about 1-2 weight percent of ferrous chloride. This product can then be used, for example, in a sewage or water treatment facility to precipitate solids. Alternatively, it can be further concentrated and purified to recover solid FeCl₃ which can be used for the same purpose. See Metcalf & Eddy, Wastewater Engineering: Treatment Disposal Reuse, 3rd Edition, 1991, revised by George Tchobanoglous and Franklin L. Burton, McGraw Hill, Inc., N.Y. pp. 303 and 304.

Without evaporation, the highest concentration of FeCl₃ achievable in the reactor is about 30% by weight. Consequently, according to another preferred embodiment of the invention, the aqueous ferric chloride solution withdrawn from the reactor and evaporated in any evaporator system, for example, the solution is heated in a heat exchanger and then passed to an atmospheric evaporator wherein an air blower is employed to cool and concentrate the solution. Evolving from the atmospheric evaporator, is a gaseous phase comprising air, hydrogen chloride and H₂O which is then passed to a scrubber in order to remove the HCl, the scrubbing preferably being conducted with an aqueous scrubbing agent, e.g. water.

The concentrated solution from the atmospheric evaporator is preferably recycled to the reactor, and by the use of sufficient evaporation and recycling the concentration of the ferric chloride is gradually increased to the desired value. The ideal flow rate to the heat exchanger is such that one can renew the reactor in 20-30 minutes. For example, if the size of the reactor is 30,000 gallons, the desired flow rate is 1,000-1,500 gal/min.

A preferred reactor, thus, comprises a batch reactor from the standpoint of the pickle liquor being supplied to the reactor, with the same reactor being continuous because of the use of a continuous recycle stream of ferric chloride solution and the continuous introduction of an oxygen-containing air stream.

According to a further embodiment of the invention, the hydrochloric acid used to acidify the pickle liquor is obtained at least partially from the above-mentioned scrubber which can be operated so as to obtain a hydrochloric acid concentration of about 8-9 weight percent. If additional hydrochloric acid is required, make-up hydrochloric acid can be supplied by a conventional source, for example in a concentrated form (an aqueous solution of 35 percent by weight of hydrochloric acid).

A gaseous phase is also recovered from the reactor and it comprises oxygen, H₂O and HCl. This gas is preferably joined with the gas leaving the atmospheric evaporator and is likewise treated in the scrubber in order to remove HCl.

It is also contemplated that it may be beneficial, when pickle liquor is treated, to send the pickle liquor through a filter, and it is also optional to remove any deleterious quantities of heavy metals by any conventional step.

According to a particularly preferred aspect of the invention, the combination of the addition of HCl to the pickle liquor and the reaction of the resultant hydrochloric acid-enriched pickle liquor in the reactor with an oxygen-containing gas at a temperature above 50° C., provides important benefits. From an overall standpoint, the present invention provides a relatively safe and economical method for the treatment of ferrous chloride wherein pickle liquor is an exemplified source of ferrous chloride.

### DESCRIPTION OF THE DRAWING

The attached drawing is a schematic representation of a preferred embodiment of the invention. The flow lines indicated in a dashed form are used merely to facilitate comprehension of the process.

Otherwise, the drawing is a self-explanatory description of a preferred comprehensive embodiment of the invention.

In the final analysis, there are several novel and unobvious aspects to the present invention, as manifested by single steps and combinations of single steps and in particular, by the comprehensive embodiment illustrated in the drawing.

A further preferred embodiment is provided as an alternative to the feature in the drawing showing oxygen being diffused into the bottom of the reactor by a diffuser terminating at the bottom of a vertical pipe charged by oxygen at the top of the pipe coming from the oxygen generator. This alternative comprises withdrawing liquid from the reactor and pumping the liquid through one or more eductors, preferably a plurality of eductors wherein oxygen from the oxygen generator is mixed with the liquid and the resultant mixture of oxygen and liquid is recycled into the reactor at one or more levels of the reactor. In particular, when the reactor has a significant height, the mixture of oxygen and liquid will be passed into the reactor at several levels so as to ensure thorough and uniform mixing in the reactor. It is further contemplated that irrespective of the size of the reactor, a mixture of oxygen and liquid will be fed into at least the bottom zone of the reactor. As for the nature of the eductor, any conventional type of eductor can be utilized.

A preferred embodiment of the eductor is a LOBESTAR mixing eductor, as disclosed for example in U.S. Pat. No. 5,664,733. For the purposes of the present invention, it is contemplated that the liquid withdrawn from the reactor and pumped into the eductor will be the motive liquid, causing a suction which will draw in the oxygen from the oxygen generator. Conversely, it is also contemplated that other eductor systems can be employed so long as they provide the function of thorough mixing and will permit the resultant mixture to be passed into the reactor at one or more levels.

### EXAMPLES

Laboratory Example

1500 ml of pickle liquor has the following properties: specific gravity-1.225, HCl-3.3%, ferrous iron-11%. To that solution is added 86 ml of 35% HCl. The temperature in the reactor is 160° F. An oxygen-containing gas is bubbled into the reactor, and the batch is evaporated to the desired concentration. At the end of the batch, the properties of the solution are: specific gravity 1.41, ferrous chloride: 2%, ferric chloride: 40%, HCl:1.8%.

Example Using An Eductor

10 L of pickle liquor has the following properties: specific gravity-1.32, HCl-1.1%, ferrous iron-13.6%. To that solution is added 3.1 L of 30% HCl. The temperature in the reactor is 160° F. An oxygen-containing gas is introduced into the eductor, which is placed on the line of reactor-pump-reactor after the pump. The batch is evaporated to the desired concentration. At the end of the batch, the properties of the solution are: specific gravity-1.41, HCl-2.5%, ferrous iron-2.0%, ferric chloride-40%, HCl-2.4%.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. A process for producing ferric chloride, said process comprising providing a source of an aqueous solution of ferrous chloride and additional chloride ion, and contacting said aqueous solution with an oxygen-containing gas at above 132° F. for a sufficient time to convert, at least in part, the ferrous chloride to ferric chloride, and recovering the ferric chloride.

2. A process according to claim 1, comprising conducting the conversion of ferrous chloride to ferric chloride, in a vertical reactor, and the oxygen-containing gas is introduced at a lower zone of the vertical reactor and the aqueous solution containing ferrous chloride is introduced at an upper zone of the reactor.

3. A process according to claim 1, comprising conducting the conversion in a reactor, withdrawing aqueous liquid containing ferric chloride from the reactor and passing said aqueous liquid into at least one eductor, passing oxygen into said eductor, and withdrawing from said eductor a liquid containing oxygen and recycling said liquid containing oxygen to the reactor.

4. A process according to claim 2, wherein said reactor is constructed from a fiber glass reinforced polymer.

5. A process according to claim 3, wherein said reactor is constructed from a fiber glass reinforced polymer.

6. A process according to claim 1, wherein said aqueous solution of ferrous chloride further comprises sufficient hydrochloric acid to convert substantially all the ferrous chloride to ferric chloride.

7. A process according to claim 2, wherein said aqueous solution of ferrous chloride further comprises sufficient hydrochloric acid to convert substantially all the ferrous chloride to ferric chloride.

8. A process according to claim 3, wherein said aqueous solution of ferrous chloride further comprises sufficient hydrochloric acid to convert substantially all the ferrous chloride to ferric chloride.

9. A process according to claim 7, further comprising withdrawing an aqueous solution of ferric chloride from the reactor and subjecting said solution of ferric chloride to evaporation so as to obtain a more concentrated solution of ferric chloride and a gaseous phase comprising air, hydrogen chloride and H₂O, and recycling said more concentrated solution of ferric chloride, at least in part, to said reactor.

10. A process according to claim 8, further comprising withdrawing an aqueous solution of ferric chloride from the reactor and subjecting said solution of ferric chloride to evaporation so as to obtain a more concentrated solution of ferric chloride and a gaseous phase comprising air, hydrogen chloride and H₂O, and recycling said more concentrated solution of ferric chloride, at least in part, to said reactor.

11. A process according to claim 9, further comprising scrubbing hydrochloric acid from said gaseous phase with an aqueous phase so as to obtain a hydrochloric acid solution and passing said hydrochloric solution, at least in part, to said aqueous solution of ferrous chloride to form said additional chloride.

12. A process according to claim 10, further comprising scrubbing hydrochloric acid from said gaseous phase with an aqueous phase so as to obtain a hydrochloric acid solution and passing said hydrochloric solution, at least in part, to said aqueous solution of ferrous chloride to form said additional chloride.

13. A process according to claim 11, further comprising withdrawing an overhead gas from said reactor, said overhead gas comprising oxygen, H₂O and HCl, and scrubbing HCl from said overhead gas conjointly with the gaseous phase leaving the evaporator.

14. A process according to claim 3, wherein the reactor is a tower and the oxygen-containing liquid from the eductor is passed into the tower at several levels.

15. A process according to claim 5, wherein the reactor is a tower and the oxygen-containing liquid from the eductor is passed into the tower at several levels.

16. A process according to claim 1, wherein the conversion of ferrous chloride to ferric chloride is conducted at a temperature of about 150-180° F. and the oxygen-containing gas comprises oxygen-enriched air having a concentration up to 100% oxygen.

17. A process according to claim 4, wherein the conversion of ferrous chloride to ferric chloride is conducted at a temperature of about 150-180° F. and the oxygen-containing gas comprises oxygen-enriched air having a concentration up to 100% oxygen.

18. A process according to claim 5, wherein the conversion of ferrous chloride to ferric chloride is conducted at a temperature of about 150-180° F. and the oxygen-containing gas comprises oxygen-enriched air having a concentration up to 100% oxygen.

19. A process according to claim 16, wherein the conversion of ferrous chloride to ferric chloride is conducted at a temperature of about 150-180° F. and the oxygen-containing gas comprises oxygen-enriched air having a concentration up to 100% oxygen.

20. Apparatus for conducting a process for converting ferrous chloride to ferric chloride, said apparatus comprising:
a vertical reactor for converting ferrous chloride to ferric chloride;
evaporator means having an inlet and outlet communicating with said vertical reactor;
means for mixing oxygen and a solution comprising ferrous chloride, communicating with said vertical reactor;
a source of oxygen communicating with said means for mixing;
a scrubber communicating with the evaporator means; and
conduit for effecting said communicating.
